(19) United States
(12) Patent Application Publication
(10) Pub. No.: US 2026/0061839 A1
(43) Pub. Date: Mar. 5, 2026

(54) SYSTEMS AND METHODS FOR INTEGRATED ACCESSORY VEHICLE CONTROL MANAGEMENT

(71) Applicant: Textron Inc., Providence, RI (US)

(72) Inventors: Preston Sering Easley, Martinez, GA (US); Cole Elliott O'Brien, North Augusta, SC (US)

(73) Assignee: Textron Inc., Providence, RI (US)

(21) Appl. No.: 18/824,310

(22) Filed: Sep. 4, 2024

(51) Int. Cl. B60K 28/12; B60R 22/48

(52) U.S. Cl. CPC B60K 28/12; B60R 22/48; B60R 2022/4816; B60R 2022/4825; B60R 2022/4841; B60R 2022/4866; B60R 2022/4891

(57) ABSTRACT

Systems and methods for controlling operation of a vehicle are described herein. According to exemplary embodiments, an off-road vehicle includes a chassis, a seating area supported by the chassis, one or more sensors configured to acquire data to facilitate detecting whether one or more conditions are met for unrestricted operation of the off-road vehicle, and a control system. The control system is configured to acquire the data from the one or more sensors and restrict operation of the off-road vehicle responsive to determining that at least one of the one or more conditions is not met. The control system is configured to permit unrestricted operation of the off-road vehicle responsive to determining that the one or more conditions are met.

### BACKGROUND

The present disclosure relates generally to a control system for a vehicle. More specifically, the present application relates to a system for controlling the operation of an off-road vehicle.

### SUMMARY

One embodiment relates to an off-road vehicle. The off-road vehicle includes a chassis, a seating area supported by the chassis, one or more sensors configured to acquire data to facilitate detecting whether one or more conditions are met for unrestricted operation of the off-road vehicle, and a control system. The control system is configured to acquire the data from the one or more sensors and restrict operation of the off-road vehicle responsive to determining that at least one of the one or more conditions is not met. The control system is configured to permit unrestricted operation of the off-road vehicle responsive to determining that the one or more conditions are met.

Another embodiment relates to an off-road vehicle. The off-road vehicle includes a chassis, a prime mover, a plurality of tractive elements, at least one of the plurality of tractive elements driven by the prime mover, and a seating area having one or more seatbelts coupled to the chassis. The off-road vehicle also includes one or more sensors that are configured to acquire data regarding a number of occupants in the off-road vehicle and are configured to acquire data regarding usage of the one or more seatbelts by the occupants and a control system. The control system is configured to acquire a first seatbelt characteristic from at least one of the one or more sensors, the first seatbelt characteristic indicating whether each occupant is properly wearing one of the one or more seatbelts and determine that each of the occupants is properly wearing one of the one or more seatbelts. Responsive to determining that each of the occupants is properly wearing one of the one or more seatbelts, the control system allows unrestricted operation of the off-road vehicle. The control system acquires a second seatbelt characteristic from at least one of the one or more sensors, the second seatbelt characteristic indicating whether each occupant is wearing one of the one or more seatbelts and determines that at least one of the occupants is not properly wearing one of the one or more seatbelts. Responsive to determining that at least one of the occupants is not properly wearing one of the one or more seatbelts, the control system restricts operation of the off-road vehicle.

Still another embodiment relates to a method. The method includes providing an off-road vehicle having one or more sensors configured to facilitate detecting whether one or more seatbelt conditions are met by an occupant. The method includes acquiring, from a seat sensor, a position of the occupant in a seating area, acquiring, from a first seatbelt sensor, seatbelt data indicative of a tension of a seatbelt or a length of the seatbelt withdrawn from a seatbelt spool, and acquiring, from a second seatbelt sensor, seatbelt data indicative of whether a seatbelt tongue is engaged with a seatbelt buckle. The method includes comparing the tension or the length of the seatbelt to a threshold and determining whether the seatbelt tongue is engaged with the seatbelt buckle. The method includes comparing the position of the occupant in the seating area to the seatbelt data from the first seatbelt sensor and the second seatbelt sensor, and determining, based on the tension or the length of the seatbelt, the seatbelt tongue engagement with the seatbelt buckle, and the position of the occupant, whether the occupant is wearing the seatbelt properly. The method includes restricting operation of the off-road vehicle by limiting a speed of the off-road vehicle to a reduced speed, or inhibiting the off-road vehicle from moving, responsive to determining that the seatbelt is not being worn or properly worn by the occupant.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a flow chart of a process for detecting whether a vehicle driving condition is met and performing a responsive action, according to an exemplary embodiment.

FIG. 5 is a flow chart of a process for detecting whether occupants are wearing a seatbelt and performing a responsive action, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

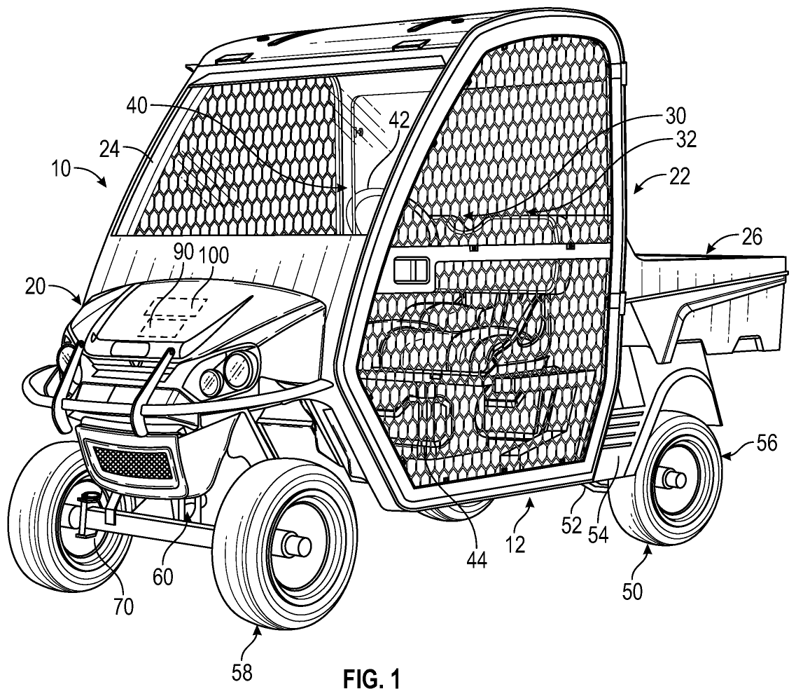

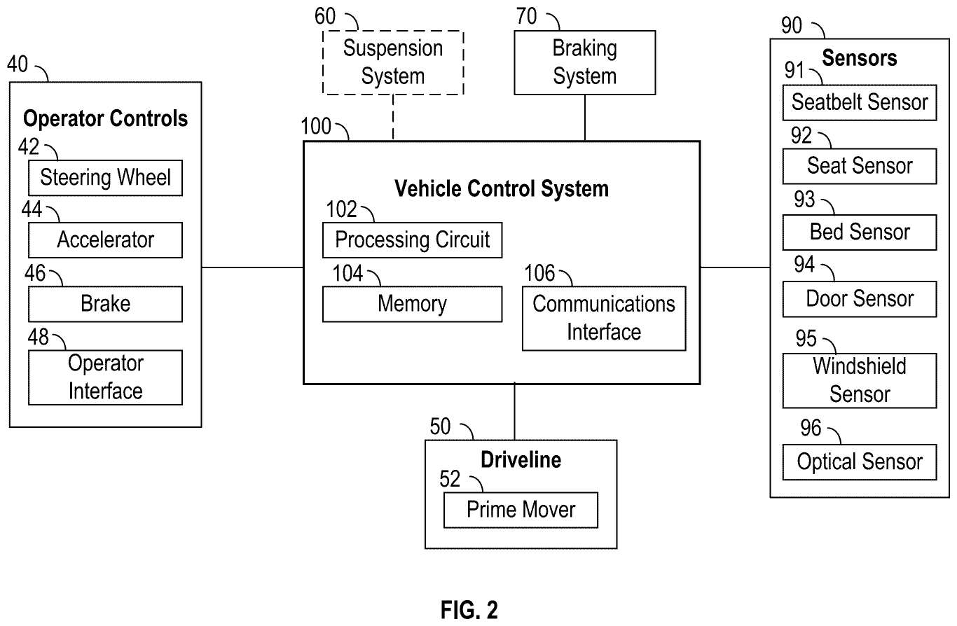

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a row of seating, shown as front row seating 32. In some embodiments, the occupant seating area 30 includes one or more seatbelts. In some embodiments, the occupant seating area 30 includes a second row of seating. In some embodiments, the occupant seating area 30 includes a third row of seating or intermediate/middle row seating positioned between the front row seating 32 and the rear row seating. As shown in FIG. 1, the body 20 includes (a) one or more doors, shown as doors 22, that selectively close and restrict access to the operator seating area 30 and (b) an environmental shield, shown as windshield 24, positioned in front of the operator seating area 30. In some embodiments, the vehicle 10 does not include the doors 22. In some embodiments, the windshield 24 is retractable, pivotable, etc. to reposition at least a portion of the windshield 24 (e.g., to permit airflow into the occupant seating area 30 through an opening where at least the portion of the windshield 24 was previously positioned). In some embodiments, the vehicle 10 does not include the windshield 24. As shown in FIG. 1, the vehicle 10 includes a rear accessory, shown as bed 26. In some embodiments, the bed 26 is replaced with another type of rear accessory. Such other rear accessories may be or include a golf bag rack, a cargo body (e.g., for a drink cart), a rear facing seat, and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown as steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 2, the sensors 90 are shown to include a seatbelt sensor 91, a seat sensor 92, a bed sensor 93, a door sensor 94, a windshield sensor 95, and an optical sensor 96 (e.g., a camera, a radar sensor, a proximity sensor, a LIDAR sensor, etc.). According to an exemplary embodiment, the sensors 90 are configured to facilitate detecting and obtaining data regarding whether certain operating parameters are met. For example, whether a seatbelt is in use, whether the windshield 24) is raised or lowered, whether the door 22 and/or a tailgate of the bed 26 is closed, whether occupants are properly situated within the occupant seating area 30, and/or other operating parameters, as described in greater detail herein.

The seatbelt sensor 91 is configured to facilitate detecting whether a seatbelt is being used and/or whether the seatbelt is being properly used. In some embodiments, the seatbelt sensor 91 is or includes a first seatbelt sensor configured (e.g., positioned) to measure an amount of length and/or a tension of a seatbelt strap withdrawn from a seatbelt spool or retractor, which may be used to determine whether the seatbelt strap is around an occupant or not around an occupant. In some embodiments, the seatbelt sensor 91 additionally or alternatively is or includes a second seatbelt sensor configured (e.g., positioned) to facilitate detecting whether a seatbelt tongue is in engagement with the seatbelt buckle. By way of example, when properly worn, the seatbelt strap will be withdrawn from the seatbelt retractor, extend around the occupant, and the seatbelt tongue will be in engagement with the seatbelt buckle. However, in some instances, the occupant may not wear the seatbelt properly or not wear the seatbelt altogether. By way of example, the occupant may buckle the seatbelt tongue to the seatbelt buckle with the seatbelt strap entirely behind them or with only the lower portion of the seatbelt strap across their waist with the upper portion of the seatbelt strap positioned behind them.

The seat sensor 92 is configured to facilitate detecting occupancy and/or occupant position in the vehicle 10. In some embodiments, the seat sensor 92 is a seat switch configured (e.g., positioned) to facilitate detecting whether an occupant is sitting on a respective seat within the occupant seating area 30. In some embodiment, the seat sensor 92 is a weight sensor configured (e.g., positioned) to facilitate detecting whether an occupant is sitting on a respective seat within the occupant seating area 30.

The bed sensor 93 is configured (e.g., positioned) to facilitate detecting a position of a tailgate of the bed 26 (e.g., closed, properly latched, open, unlatched). The door sensor 94 is configured (e.g., positioned) to facilitate detecting a position of the doors 22 (e.g., closed, properly latched, open, unlatched). The windshield sensor 95 is configured (e.g., positioned) to facilitate detecting a position or orientation of the windshield 24 (e.g., open, closed, retracted, stowed, deployed, unfolded, folded, lifted, lowered, etc.).

The optical sensor 96 is configured to acquire vision data configured to facilitate detecting one or more conditions of the vehicle 10 (e.g., using machine vision/recognition, etc.). By way of example, the optical sensor 96 may be configured to acquire occupant data regarding the number and positioning of occupants within the occupant seating area 30. The positioning of occupants may include which seat a respective occupant is sitting, whether the respective occupant is sitting normally, and/or whether the occupant is situated with one or more limbs extending out of the vehicle 10 (e.g., whether arms and/or legs of the respective occupant are inside or outside the occupant seating area 30). By way of another example, the optical sensor 96 may be configured to acquire seatbelt data regarding whether each of the occupants are wearing and/or properly wearing a seatbelt. By way of still another example, the optical sensor 96 may be configured to acquire door data regarding whether the doors 22 are open or closed. By way of yet another example, the optical sensor 96 may be configured to acquire windshield data regarding a position or orientation of the windshield 24 (e.g., open, closed, retracted, stowed, deployed, unfolded, folded, lifted, lowered, etc.).

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

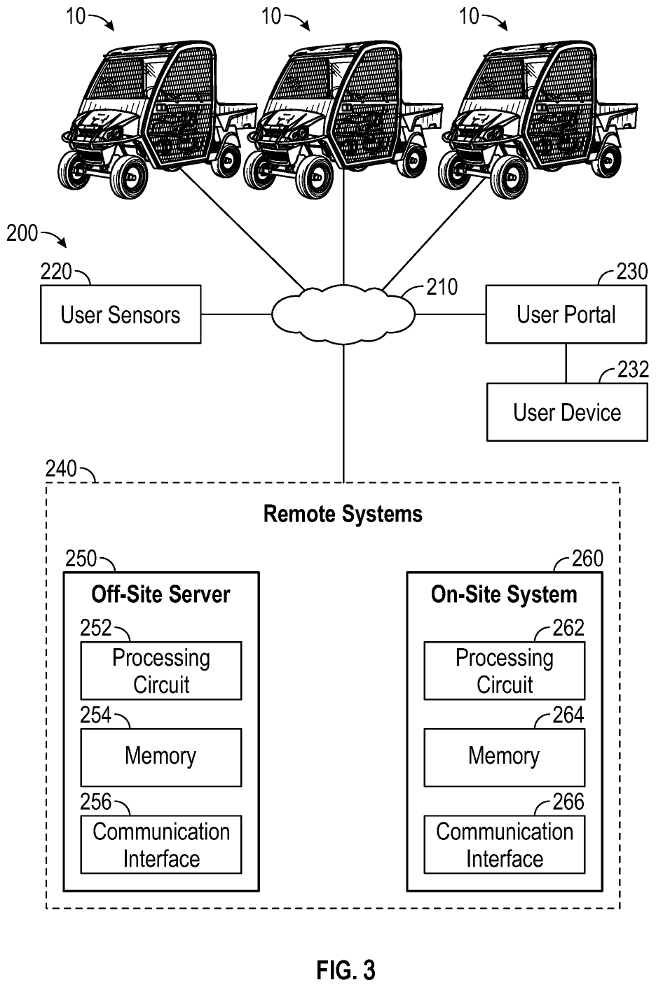

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Vehicle Control Based on Vehicle Accessory Usage

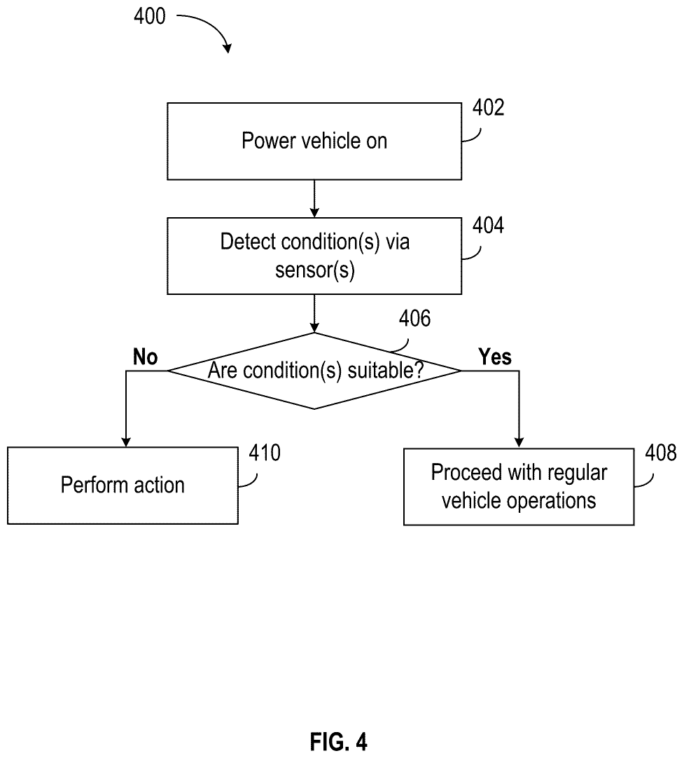

Referring to FIG. 4, a flow chart of a process 400 (e.g., performed by the vehicle control system 100, the remote systems 240, etc.) for detecting whether one or more accessory conditions/parameters are met and moderating (e.g., modulating, adjusting, limiting, preventing, etc.) operations of the vehicle 10 accordingly is shown, according to an exemplary embodiment. It should be understood that the process 400 may be performed by the vehicle control system 100 alone or by the vehicle control system 100 and the remote systems 240 together. As discussed above, the vehicle 10 may include one or more accessories, such as seatbelts, the doors 24, the windshield 24, the bed 26, and the other systems shown in FIGS. 1 and 2.

At step 402, the vehicle 10 is powered on (e.g., by turning a key in the ignition, by pressing a power-button, after sitting stationary for a period of time, etc.). Once powered on, the vehicle 10 powers the sensors 90 (e.g., the seatbelt sensor 91, the seat sensor 92, the bed sensor 93, the door sensor 94, the windshield sensor 95, the optical sensor 96, etc.).

At step 404, the vehicle control system 100 and/or the remote systems 240 are configured to acquire data from one or more of the sensors 90 to facilitate detecting one or more conditions of the vehicle 10. A first condition may be whether each of the occupants within the vehicle 10 is or is not wearing or not properly wearing a seatbelt. The vehicle control system 100 and/or the remote systems 240 may be configured to acquire data from the seatbelt sensor 91, the seat sensor 92, and/or the optical sensor 96 to detect the first condition. A second condition may be whether the doors 22 of the vehicle 10 are fully closed and latched or open/ajar. The vehicle control system 100 and/or the remote systems 240 may be configured to acquire data from the door sensor 94 and/or the optical sensor 96 to detect the second condition. A third condition may be whether the windshield 24 of the vehicle 10 is closed or open/retracted. The vehicle control system 100 and/or the remote systems 240 may be configured to acquire data from the windshield sensor 95 and/or the optical sensor 96 to detect the third condition. A fourth condition may be whether a tailgate of the bed 26 is closed and latched or open/ajar. The vehicle control system 100 and/or the remote systems 240 may be configured to acquire data from the bed sensor 93 to detect the fourth condition. A fifth condition may be that a portion of an occupant is extending outside of the occupant seating area 30 and the vehicle 10. The vehicle control system 100 and/or the remote systems 240 may be configured to acquire data from the optical sensor 96 to detect the fifth condition.

In some embodiments, the vehicle control system 100 and/or the remote systems 240 store data related to the one or more conditions. By way of example, the vehicle control system 100 and/or the remote systems 240 may store a seatbelt tension threshold value, a minimum seatbelt engagement length, a model seatbelt position, and operational parameters regarding windshield and door position (e.g., true/false values regarding whether the windshield 24, the doors 22, and/or the tailgate are in a position acceptable for driving the vehicle 10).

At step 406, the vehicle control system 100 and/or the remote systems 240 determine whether the one or more conditions (e.g., seatbelt use, windshield position, door status, tailgate status, occupant orientation, etc.) are suitable for unrestricted, normal, or regular operation of the vehicle 10 based on the data acquired from the sensors 90. Upon determining that the one or more conditions are suitable for unrestricted, normal, or regular operation of the vehicle 10, the vehicle control system 100 and/or the remote systems 240 proceed to step 408, where the vehicle 10 is allowed to proceed with unrestricted, normal, or regular operation (e.g., performance of the vehicle 10 is not limited in any way, no warnings are provided to the operator, etc.). However, upon determining that the one or more conditions are not suitable for unrestricted, normal, or regular operation of the vehicle 10, the vehicle control system 100 and/or the remote systems 240 proceed to step 410

At step 410, the vehicle control system 100 and/or the remote systems 240 are configured to perform an action. The action may include limiting speed of the vehicle 10, preventing operation of the vehicle 10, providing an alert to the operator (e.g., on a display, via a speaker, via the operator interface 48, etc.), and/or still another action. In some embodiments, the vehicle control system 100 and/or the remote systems 240 perform an action that is unique to and based on the one or more conditions. In other embodiments, the vehicle control system 100 and/or the remote systems 240 perform a single action regardless of what condition is not met.

By way of example, the vehicle control system 100 and/or the remote systems 240 may inhibit the vehicle 10 from moving or limit the speed of the vehicle 10 to a reduced speed (e.g., 5 mph or slower, by engaging the braking system 70, by preventing operation of the prime mover 52, etc.) upon determining the doors 22 are open, while not limit the speed of the vehicle 10 when the doors 22 are closed. By way of another example, the vehicle control system 100 and/or the remote systems 240 may limit the speed of the vehicle to a reduced speed (e.g., 10 mph or slower) upon determining that the windshield 24 is fully or partially retracted or open, while not limit the speed of the vehicle 10 when the windshield 24 is closed or up. By way of another example, the vehicle control system 100 and/or the remote systems 240 may inhibit the vehicle 10 from moving or limit the speed of the vehicle 10 to a reduced speed (e.g., 2 mph, 5, mph, etc.) upon determining that a limb of an occupant is outside of the occupant seating area 30 (e.g., a foot or leg is resting off to the side of a seat and on the exterior of frame 12 of the vehicle 10) while not limit the speed of the vehicle 10 when the occupants are fully within the occupant seating area. By way of another example, the vehicle control system 100 and/or the remote systems 240 may inhibit the vehicle 10 from moving or limit the speed of the vehicle 10 to a reduced speed (e.g., 5 mph or slower, by engaging the braking system 70, by preventing operation of the prime mover 52, etc.) upon determining the tailgate of the bed 26 is open, while not limit the speed of the vehicle 10 when the tailgate is closed. By way of another example, the vehicle control system 100 and/or the remote systems 240 may inhibit the vehicle 10 from moving or limit the speed of the vehicle 10 to a reduced speed (e.g., 5 mph or slower, by engaging the braking system 70, by preventing operation of the prime mover 52, etc.) upon determining the a seatbelt is not being worn or is not properly being worn by an occupant within the occupant seating area 30, while not limit the speed of the vehicle 10 when the seatbelt is properly worn. In other examples, the vehicle control system 100 and/or the remote systems are configured to inhibit movement or reduce the speed of the vehicle 10 upon determining that any condition is not met. In addition or as an alternative to the examples described above, the vehicle control system 100 may operate a user interface, such as the operator interface 48, to display a notification regarding the condition (e.g., what condition is not met, what action should be taken, what limitation will be imposed, etc.).

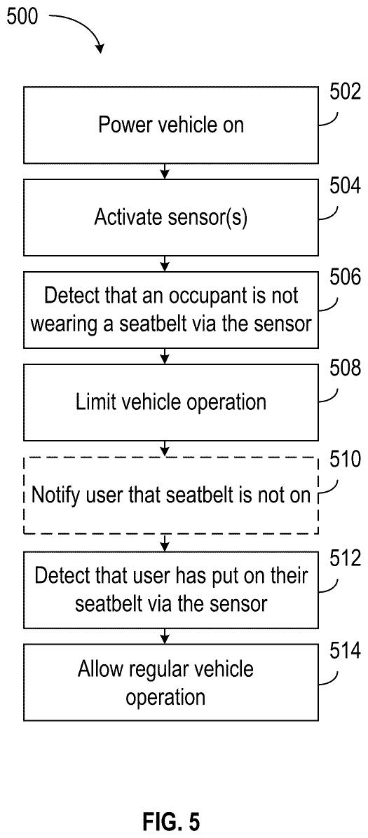

Referring to FIG. 5, a flow chart of a process 500 (e.g., performed by the vehicle control system 100, the remote systems 240, etc.) for limiting operation of the vehicle 10 based on seatbelt usage is shown, according to an exemplary embodiment.

At step 502, the vehicle 10 is powered on (e.g., by turning a key in the ignition, by pressing a power-off button, after sitting stationary for a period of time, etc.). Once powered on, the vehicle 10 powers the sensors 90 (e.g., the seatbelt sensor 91, the seat sensor 92, the bed sensor 93, the door sensor 94, the windshield sensor 95, the optical sensor 96, etc.). At step 504 at least one sensor is activated. Specifically, at least the seatbelt sensor 91 is activated. In exemplary embodiments, the seatbelt sensor 91 is coupled with a seatbelt (e.g., to a seatbelt retractor, to a seatbelt buckle, etc.). In some examples, a seatbelt sensor 91 is provided for each seatbelt in the vehicle 10.

At step 506, the vehicle control system 100 and/or the remote systems 240 detect that an occupant is not wearing a seatbelt and/or the occupant is not properly wearing the seatbelt based on the data transmitted from the sensors 90. In exemplary embodiments, the data acquired by the seatbelt sensor 91 is utilized by the control system 100 and/or the remote systems 240 to determine whether or not an occupant is wearing a seatbelt and/or the occupant is not properly wearing the seatbelt. As discussed above, the seatbelt sensor 91 is or includes a first seatbelt sensor configured (e.g., positioned) to measure an amount of length and/or a tension of a seatbelt strap withdrawn from a seatbelt spool or retractor, which may be used to determine whether the seatbelt strap is around an occupant or not around an occupant. In some examples, a predetermined tension threshold value is stored on the memory 104. The tension threshold may, for example, be set by a provider based on statistical data regarding the tension of a seatbelt when being worn properly by an occupant. In exemplary embodiments, the seatbelt sensor 91 measures a tension value or a set of tension values for a predetermined period of time after the vehicle 10 is powered on (e.g., 30 seconds, one minute, two minutes, etc.). The tension value or values are transmitted to the vehicle control system 100, which determines whether the tension value, average tension value, or most recent tension value is at or above the tension threshold. A tension above the tension threshold indicates that an occupant is wearing a seatbelt, whereas a tension below the tension threshold indicates that an occupant is not wearing a seatbelt or is wearing a seatbelt improperly. In some examples, a minimum seatbelt engagement length is stored on the memory 104. The minimum seatbelt engagement length may, for example, be set by a provider based on statistical data regarding the length of seatbelt withdrawn from the seatbelt spool or retractor when being worn properly by the occupant. The length of the seatbelt withdrawn from the seatbelt spool or retractor is transmitted to the control system which determines whether the seatbelt engagement length is above the minimum seatbelt engagement length value. A seatbelt engagement length below the minimum seatbelt engagement length value indicates that an occupant is not wearing a seatbelt or is wearing a seatbelt improperly. Conversely, a seatbelt engagement length above the minimum seatbelt engagement length value indicates that an occupant is wearing a seatbelt properly. Additionally or alternatively, the seatbelt sensor 91 includes a second seatbelt sensor configured (e.g., positioned) to facilitate detecting whether a seatbelt tongue is in engagement with the seatbelt buckle.

Additionally or alternatively, data acquired by seat sensor 92 and/or the optical sensor 96 is utilized by the vehicle control system 100 and/or the remote systems 240 to detect whether an occupant is wearing a seatbelt. In some examples, the optical sensor 96 acquires data associated with the position of the seatbelts in the vehicle 10. The optical sensor 96 and/or the seat sensors 92 may additionally acquire data regarding the number of vehicle occupants and the position of the occupants in the seating area 30. In some examples, the vehicle control system 100 stores one or more acceptable seatbelt positions. The acceptable seatbelt positions may be, for example, determined based on a model position of a seatbelt relative to a model occupant. By way of example, the optical sensor 96 transmits optical data indicative of the position of seatbelts relative to the vehicle occupants. In this example, the vehicle control system 100 compares the optical data transmitted by the optical sensor 96 to the model position of a seatbelt relative to the model occupant to determine whether each of the occupants in the vehicle 10 is wearing a seatbelt.

At step 508, the vehicle control system 100 limits the operation of the vehicle 10 responsive to detecting an occupant is not wearing a seatbelt or is improperly wearing a seatbelt. For example, the vehicle control system 100 limits the speed of the vehicle 10 to a reduced speed (e.g., 5 mph or slower) or inhibits the vehicle 10 from moving (e.g., by engaging the braking system 70, by preventing operation of the prime mover 52, etc.). By way of example, the vehicle control system 100 may utilize a combination of data collected by the sensors 90 to determine the number of seatbelts in use versus the number of occupants in the vehicle 10. For example, the vehicle control system 100 may utilize the seat sensor 92 data regarding whether an occupant is sitting on a respective seat in the occupant seating area 30 in combination with the seatbelt tension/length and buckle engagement data from the seatbelt sensor 91 to determine that each occupant is wearing a seatbelt. The vehicle control system 100 may compare the position of the occupants to the position of the seatbelts having a tension/length value above the tension/length threshold and are engaged with a buckle to confirm that each occupant is wearing a seatbelt (e.g., to prevent “cheating” by buckling a seatbelt in an empty seat). In this way, the vehicle control system 100 allows regular vehicle operation, for example, upon determining that one occupant is in the vehicle 10 and the one occupant is wearing a seatbelt, even when the remaining seatbelts are not being used.

At optional step 510, the vehicle control system 100 transmits a notification to the operator interface 48 responsive to determining that an occupant is not wearing a seatbelt. In some examples, the operator interface 48 displays a graphical user interface that includes a graphical representation regarding an occupant's seatbelt not being on (e.g., a seatbelt symbol, text, or the like). In some examples, the graphical representation identifies the position of an occupant that is not wearing or improperly wearing a seatbelt. Additionally or alternatively, the operator interface provides an audial notification (e.g., an alarm, a narrative regarding seatbelt usage, etc.).

At step 512, the vehicle control system 100 detects that an occupant is wearing a seatbelt based on the data transmitted from the sensors 90. By way of example, the control system 100 and/or the remote systems 240 may determine that a seatbelt is being properly worn by an occupant when the tension/length is at or above the tension/length threshold, and the seatbelt tongue is engaged with the seatbelt buckle. In other examples, the vehicle control system 100 and/or the remote systems 240 detects that the occupant or occupants are wearing seatbelts based on optical data transmitted by the optical sensor 96. For example, the vehicle control system 100 and/or the remote systems 240 compares the position of a seatbelt relative to each occupant. If the seatbelt position relative to each occupant generally matches the model seatbelt position relative to the model occupant, then the control system 100 and/or the remote system 240 determines that the occupants are each wearing a seatbelt properly. Upon determining that each occupant is wearing a seatbelt properly, at step 512, the vehicle control system 100 stops imposing limits on the vehicle 10 speed and allows unrestricted, regular, or normal operation of the vehicle 10.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. An off-road vehicle, comprising:
a chassis;
a seating area supported by the chassis;
one or more sensors configured to acquire data to facilitate detecting whether one or more conditions are met for unrestricted operation of the off-road vehicle;
a control system configured to:
acquire the data from the one or more sensors;
restrict operation of the off-road vehicle responsive to determining that at least one of the one or more conditions is not met; and
permit unrestricted operation of the off-road vehicle responsive to determining that the one or more conditions are met.

2. The off-road vehicle of claim 1, wherein the control system is configured to operate an alarm in response to determining that the one or more conditions are not met.

3. The off-road vehicle of claim 1, further comprising a display device, wherein the control system is configured to operate the display device to display a notification regarding at least one of the one or more conditions that is not met.

4. The off-road vehicle of claim 1, wherein the one or more sensors include at least one of (a) a seatbelt sensor, (b) a seat sensor, (c) a bed sensor, (d) a door sensor, (e) a windshield sensor, or (f) an optical sensor.

5. The off-road vehicle of claim 4, wherein the one or more conditions includes at least one of (a) a seatbelt being properly worn by an occupant, (b) a tailgate of the off-road vehicle being closed, (c) a door of the off-road vehicle being closed, (d) a windshield of the off-road vehicle being closed, or (e) limbs of the occupant being inside the seating area of the off-road vehicle.

6. The off-road vehicle of claim 5, wherein the one or more sensors include the seatbelt sensor, and wherein the control system is configured to:
acquire, from the seatbelt sensor, a tension value of the seatbelt;
compare the tension value of the seatbelt to a threshold;
determine, based on the comparison, whether the occupant is wearing the seatbelt; and
responsive to determining that the seatbelt is not being worn or properly worn by the occupant, restrict operation of the off-road vehicle by:
(a) limiting a speed of the off-road vehicle to a reduced speed, or
(b) inhibiting the off-road vehicle from moving.

7. The off-road vehicle of claim 5, wherein the one or more sensors include the seatbelt sensor, and wherein the control system is configured to:
acquire, from the seatbelt sensor, seatbelt data indicative of a length of the seatbelt withdrawn from a seatbelt spool and indicative of whether a seatbelt tongue is engaged with a seatbelt buckle;
compare the length of the seatbelt withdrawn from the seatbelt spool to a minimum seatbelt engagement length;
determine, based on the comparison, whether the occupant is wearing the seatbelt based on the length and the seatbelt tongue engagement with the seatbelt buckle; and
responsive to determining that the seatbelt is not being worn or properly worn by the occupant, restrict operation of the off-road vehicle by:
(a) limiting a speed of the off-road vehicle to a reduced speed, or
(b) inhibiting the off-road vehicle from moving.

8. The off-road vehicle of claim 5, wherein the one or more sensors include the optical sensor, and wherein the control system is configured to:
receive, from the optical sensor, optical data indicative of a position of the seatbelt relative to the occupant;
acquire a model seatbelt position relative to a model occupant when being properly worn by the model occupant;
compare the optical data indicative of the position of the seatbelt of the occupant relative to the model seatbelt position of the model occupant to determine whether the occupant is properly wearing the seatbelt; and
responsive to determining that the occupant is not properly wearing the seatbelt, restrict operation of the off-road vehicle by:
(a) limiting a speed of the off-road vehicle to a reduced speed, or
(b) inhibiting the off-road vehicle from moving.

9. The off-road vehicle of claim 5, further comprising a bed supported by the chassis, wherein the bed includes the tailgate, wherein the one or more sensors include the bed sensor, and wherein the control system is configured to:
acquire, from the bed sensor, tailgate data indicative of whether the tailgate is in an open position or a closed position;
determine whether the tailgate is in the open position or the closed position based on the tailgate data; and
responsive to determining that the tailgate is in the open position, restrict operation of the off-road vehicle by:
(a) limiting a speed of the off-road vehicle to a reduced speed, or
(b) inhibiting the off-road vehicle from moving.

10. The off-road vehicle of claim 5, further comprising a body providing the seating area, wherein the body includes a door, wherein the one or more sensors include the door sensor, and wherein the control system is configured to:
acquire, from the door sensor, door data indicative of whether the door is in an open position or a closed position;
determine whether the door is in the open position or the closed position based on the door data; and
responsive to determining that the door is in the open position, restrict operation of the off-road vehicle by:
(a) limiting a speed of the off-road vehicle to a reduced speed, or
(b) inhibiting the off-road vehicle from moving.

11. The off-road vehicle of claim 5, further comprising a windshield, wherein the one or more sensors include the windshield sensor, and wherein the control system is configured to:
acquire, from the windshield sensor, windshield data indicative of whether the windshield is in an open position or a closed position;
determine whether the windshield is in the open position or the closed position based on the windshield data; and
responsive to determining that the windshield is in the open position, restrict operation of the off-road vehicle by:
(a) limiting a speed of the off-road vehicle to a reduced speed, or
(b) inhibiting the off-road vehicle from moving.

12. The off-road vehicle of claim 5, wherein the one or more sensors include the optical sensor, and wherein the control system is configured to:
acquire, from the optical sensor, optical data indicative of whether limbs of the occupant are inside the seating area of the off-road vehicle;
determine whether each of the limbs of the occupant are inside the seating area based on the optical data; and
responsive to determining that one or more of the limbs of the occupant are not inside the seating area, restrict operation of the off-road vehicle by:
(a) limiting a speed of the off-road vehicle to a reduced speed, or
(b) inhibiting the off-road vehicle from moving.

13. An off-road vehicle comprising:
a chassis;
a prime mover;
a plurality of tractive elements, at least one of the plurality of tractive elements driven by the prime mover;
a seating area having one or more seatbelts coupled to the chassis;
one or more sensors configured to acquire data regarding a number of occupants in the off-road vehicle and configured to acquire data regarding usage of the one or more seatbelts by the occupants; and
a control system configured to:
acquire a first seatbelt characteristic from at least one of the one or more sensors, the first seatbelt characteristic indicating whether each occupant is properly wearing one of the one or more seatbelts;
determine that each of the occupants is properly wearing one of the one or more seatbelts;
allow unrestricted operation of the off-road vehicle;
acquire a second seatbelt characteristic from at least one of the one or more sensors, the second seatbelt characteristic indicating whether each occupant is wearing one of the one or more seatbelts;
determine that at least one of the occupants is not properly wearing one of the one or more seatbelts; and
restrict operation of the off-road vehicle.

14. The off-road vehicle of claim 13, wherein the control system is configured to restrict the operation of the off-road vehicle by limiting a speed of the off-road vehicle to a reduced speed in response to determining that one or more of the occupants is not wearing a seatbelt.

15. The off-road vehicle of claim 13, wherein the control system is configured to operate an alarm in response to determining that one or more of the occupants is not wearing one of the one or more seatbelts.

16. The off-road vehicle of claim 15, wherein the one or more sensors include at least one of (a) a seatbelt sensor, (b) an optical sensor, or (c) a seat sensor.

17. The off-road vehicle of claim 16, wherein the one or more sensors include the optical sensor, and wherein the control system is configured to:
acquire, from the optical sensor, optical data indicative of a position of the one or more seatbelts relative to the occupants;
acquire a model seatbelt position relative to a model occupant when being worn by the model occupant;
compare the optical data indicative of the position of the one or more seatbelts of each of the occupants relative to the model seatbelt position of the model occupant to determine whether each of the occupants is properly wearing one of the one or more seatbelts; and
responsive to determining that one or more of the occupants is not wearing or properly wearing one of the one or more seatbelts, restrict operation of the off-road vehicle by:
(a) limiting a speed of the off-road vehicle to a reduced speed, or
(b) inhibiting the off-road vehicle from moving.

18. The off-road vehicle of claim 16, wherein the one or more sensors include the seatbelt sensor, and wherein the control system is configured to:
acquire, from the seatbelt sensor, a tension value of each of the one or more seatbelts;
compare the tension value of each of the one or more seatbelts to a threshold;
compare a number of seatbelts having a tension value above the threshold to the number of occupants in the off-road vehicle;
determine, based on the comparison, whether each occupant is properly wearing one of the one or more seatbelts; and
responsive to determining that one or more of the occupants is not wearing or not properly wearing one of the one or more seatbelts, restrict operation of the off-road vehicle by:
(a) limiting a speed of the off-road vehicle to a reduced speed, or
(b) inhibiting the off-road vehicle from moving.

19. A method, comprising:
providing an off-road vehicle having one or more sensors configured to facilitate detecting whether one or more seatbelt conditions are met by an occupant;
acquiring, from a seat sensor, a position of the occupant in a seating area;
acquiring, from a first seatbelt sensor, seatbelt data indicative of a tension of a seatbelt or a length of the seatbelt withdrawn from a seatbelt spool;
acquiring, from a second seatbelt sensor, seatbelt data indicative of whether a seatbelt tongue is engaged with a seatbelt buckle;
comparing the tension or the length of the seatbelt to a threshold;
determining whether the seatbelt tongue is engaged with the seatbelt buckle;
comparing the position of the occupant in the seating area to the seatbelt data from the first seatbelt sensor and the second seatbelt sensor;
determining, based on the tension or the length of the seatbelt, the seatbelt tongue engagement with the seatbelt buckle, and the position of the occupant, whether the occupant is wearing the seatbelt properly; and
responsive to determining that the seatbelt is not being worn or properly worn by the occupant, restricting operation of the off-road vehicle by:
(a) limiting a speed of the off-road vehicle to a reduced speed, or
(b) inhibiting the off-road vehicle from moving.

20. The method of claim 19, further comprising:
operating a display device to display a notification regarding at least one of the one or more seatbelt conditions that is not met.
